(19) United States
(12) Patent Application Publication
(10) Pub. No.: US 2008/0066400 A1
(43) Pub. Date: Mar. 20, 2008

(54) SELF-SEALING STRUCTURAL INSTALLATION STRIP ASSEMBLY

(76) Inventor: Thomas J. Heppner, Warroad, MN (US)

Correspondence Address: SCHWEGMAN, LUNDBERG & WOESSNER, P.A., P.O. BOX 2938, MINNEAPOLIS, MN, 55402, US

(21) Appl. No.: 11/533,224

(22) Filed: Sep. 19, 2006

(51) Int. Cl. E06B 3/00

(52) U.S. Cl. 52/204.55

(57) ABSTRACT

Self-sealing structural installation strip assemblies for a framed unit are discussed. The installation strip assembly comprises a main body having an inner portion and an outer portion. In some examples, a leg of the inner portion, in conjunction with portions of a unit groove seal, are received and retained in a groove of a unit frame member. The unit groove seal provides a seal between the installation strip assembly and the framed unit. At the building site, the installation strip may be folded from a substantially flush position with respect to a frame member to an outwardly extending position so that the strip may be secured using one or more fasteners to a building structure extending around a rough unit opening. The upper portion of the main body may include at least one of a fastener seal, a flashing seal, or a wall seal.

### TECHNICAL FIELD

This patent document pertains generally to the securement of a window, door, or other framed unit to a support structure surrounding a rough unit opening in a building or other structure. More particularly, but not by way of limitation, this patent document pertains to a self-sealing structural installation strip assembly.

### BACKGROUND

One of the most common failure points where water or other moisture enters a building's envelop is around window and door units. Water and other moisture penetration is one of the most significant factors leading to premature failure of a building or other structure. Many window and door units are installed in a building's rough opening by either nailing the window or door unit's molding to the support structure surrounding the rough opening or by nailing one or more installation strips, such as one or more nail fins, of the window or door unit to the surrounding support structure. In those window or door units which have one or more installation strips, the strips are typically made of plastic and may inopportunely break under certain environment conditions or if too much force is applied to the strips.

Conventionally, each installation strip is attached to a window or door unit frame at the factory and extend outwardly in a fixed position from the unit frame. The outwardly extending installation strips make it somewhat difficult to ship the window or door unit from the factory to the building site due to its increased height and width. For instance, many conventional installation strips do not allow the window or door units to stand by themselves unaided; instead, they require special blocking or packaging.

Installation methods of window and door units vary significantly and range from as little as detached building paper lapping over or under the window or door unit installation strips to detached flashing materials being shingled in the rough opening prior to window or door unit installation. Additional installation methods for window and door units include application of caulking installed from a tube caulk gun under the window or door unit installation strips, and various flashing or adhesive tapes applied over the window or door unit installation strips.

Installation of window units, for example, is often performed from ladders or scaffolding at various levels above the ground. As a result, the detached flashing materials or other moisture barriers are often misaligned or applied in an inconsistent manner that leaves wrinkles or voids in such material(s) leading to leaks (i.e., direct water or moisture pathways to the underlying building support structure). Further, since there is often a time lapse between installations of the various moisture barrier components, they are often damaged by wind, rain, or other mechanical disturbances.

What is needed is an installation strip assembly providing adequate structural support to a window or door unit upon installation and which may compactly fold down for shipment from a factory to a building site. What is further needed is a means to adequately seal around the window or door unit and the building or other structure to which the window or door unit is installed in a time efficient and cost effective manner.

### SUMMARY

Self-sealing structural installation strip assemblies for a framed unit are discussed. The installation strip assembly comprises a main body having an inner portion and an outer portion. In some examples, a leg of the inner portion, in conjunction with portions of a unit groove seal, are received and retained in a groove of a unit frame member. The unit groove seal provides a seal between the installation strip assembly and the framed unit. At the building site, the installation strip may be folded from a substantially flush position with respect to a frame member to an outwardly extending position so that the strip may be secured using one or more fasteners to a building structure extending around a rough unit opening. The upper portion of the main body may include at least one of a fastener seal, a flashing seal, or a wall seal.

In Example 1, an installation strip assembly comprises a main body having an inner portion and an outer portion interconnected along a fold line, the inner portion including a groove insertion leg which extends transversely from an adjacent portion of the main body; a unit groove seal disposed, in part, on the inner portion of the main body, the unit groove seal having at least one groove sidewall engageable protrusion; at least one of a fastener seal or a flashing seal disposed on the outer portion of the main body; and the groove insertion leg of the main body and the portion of the unit groove seal including the at least one groove engageable protrusion together forming a unit groove insertion portion.

In Example 2, the installation strip assembly of Example 1 optionally includes a wall seal disposed at an outer end of the main body outer portion.

In Example 3, the installation strip assembly of Examples 1-2 is optionally configured such that the fold line is covered by a portion of the unit groove seal.

In Example 4, the installation strip assembly of Examples 1-3 is optionally configured such that the unit groove seal extends from the groove insertion leg to a location on the outer portion of the main body near the fold line.

In Example 5, the installation strip assembly of Examples 1-4 optionally includes one or more fastener holes sized and position to receive an installation fastener.

In Example 6, the installation strip assembly of Examples 1-5 is optionally configured such that the main body comprises a metal.

In Example 7, an installation strip assembly comprises a main body having an inner portion and an outer portion interconnected along a fold line, the inner portion including a groove insertion leg which extends transversely from an adjacent portion of the main body; a unit groove seal disposed, in part, on the inner portion of the main body, the unit groove seal having at least one groove sidewall engageable protrusion; and the groove insertion leg of the main body and the portion of the unit groove seal including the at least one groove engageable protrusion together forming a unit groove insertion portion.

In Example 8, the installation strip assembly of Example 7 optionally includes a wall seal disposed at an outer end of the main body outer portion.

In Example 9, the installation strip assembly of Examples 7-8 is optionally configured such that the unit groove seal extends from the groove insertion leg to a location on the outer portion of the main body near the fold line.

In Example 10, the installation strip assembly of Examples 7-9 is optionally configured such that the main body comprises a metal.

In Example 11, an installation strip assembly insertable into a groove of a unit frame member comprises a main body having an inner portion and an outer portion interconnected along a fold line, the inner portion including a groove insertion leg which extends transversely from an adjacent portion of the main body; at least one of a fastener seal or a flashing seal disposed on an installation fastener receiving portion of the main body; and the groove of the unit frame member receives and retains the groove insertion leg therein.

In Example 12, the installation strip assembly of Example 11 optionally includes a wall seal disposed at an outer end of the main body outer portion.

In Example 13, the installation strip assembly of Examples 11-12 is optionally configured such that the main body comprises a metal.

In Example 14, the installation strip assembly of Examples 11-13 is optionally configured such that the fastener seal is disposed on a front side surface of the main body and the flashing seal is disposed on a back side surface of the main body.

In Example 15, an apparatus comprises a window or door unit in a plane having a frame including at least a top and two oppositely positioned side members, at least one of the frame members having an outside face oriented perpendicular to the plane and having a groove extending along a length thereof; one or more installation strip assemblies, including a main body having an inner portion and an outer portion interconnected along a fold line, the inner portion including a groove insertion leg extending transversely from an adjacent portion of the main body; a unit groove seal disposed, in part, on the inner portion of the main body, the unit groove seal extending from around the groove insertion leg to a location past the fold line on the outer portion of the main body; at least one of a fastener seal or a flashing seal disposed on the outer portion of the main body; and the groove of the window or door unit receives and retains the groove insertion leg and portions of the unit groove seal disposed on the groove insertion leg therein.

In Example 16, the apparatus of Example 15 optionally includes a wall seal disposed at an outer end of the main body outer portion.

In Example 17, the apparatus of Examples 15-16 is optionally configured such that at least one installation strip assembly longitudinally extends a substantial portion of a length of a corresponding frame member.

In Example 18, the apparatus of Examples 15-17 is optionally configured such that each installation strip assembly is pivotable between a closed position in which the installation strip lies substantially flush against a corresponding frame member outside face and an open position in which the installation strip extends outwardly from the corresponding frame outside face.

In Example 19, the apparatus of Examples 15-18 is optionally configured such that the unit groove seal is positioned, in part, over the fold line to prevent moisture passing therethrough.

In Example 20, the apparatus of Examples 15-19 is optionally configured such that the unit groove seal includes one or more groove sidewall engageable protrusions securing each installation strip assembly within the groove of a corresponding frame member.

In Example 21, the apparatus of Examples 15-20 is optionally configured such that the main body comprises a metal.]

In Example 22, the apparatus of Examples 15-21 optionally includes an installation fastener extending from a proximal end to a distal end, the proximal end including an installation strip engagement portion and the distal end including a support structure attachment portion.

The present assemblies, apparatuses, and methods related thereto provide numerous advantages over conventional installation strips. As one example, the present installation strip assemblies provide structural support to an installed window or door unit by way of a main body, a leg portion of which is insertable into a frame member groove of the window or door unit. As another example, the present installation strip assemblies may include one or more bend openings allowing the strips to compactly fold down against corresponding frame members of the window or door unit prior to use, such as during shipment from the factory to the job or building site. Both the leg portion of the main body and the one or more bend openings may be covered by portions of a unit groove seal, which prevents moisture from seeping in behind the installation strip assembly, and thus between the installation strip assembly and the building or other structure to which the window or door unit is attached. As yet another example, the present installation strip assemblies may include at least one of a fastener seal or a flashing seal, which provide a seal between one or more installation fasteners and the main body. By way of the fastener seal or the flashing seal, potentially damaging water or other types of moisture is prevented from penetrating through the fastener holes in the installation strip assembly.

These and other examples, advantages, and features of the present assemblies, apparatuses, and methods related thereto will be set forth in part in the detailed description, which follows, and in part will become apparent to those skilled in the art by reference to the following description of the present assemblies, apparatuses, methods, and drawings or by practice of the same.

### BRIEF DESCRIPTION OF THE DRAWINGS

In the drawings, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1A is a schematic view of one or more window units, one or more door units, and a finished environment in which the window and door units may be used, as constructed in accordance with at least one embodiment.

FIG. 1B is a schematic view of one or more window units, one or more door units, and a structural support environment to which the window and door units may be attached, as constructed in accordance with at least one embodiment.

FIG. 2 is an isometric view of a window unit and one or more installation strip assemblies attached thereto, as constructed in accordance with at least one embodiment.

FIG. 3 is a schematic view of a window unit, an installation strip assembly, an installation fastener, and a structural support member to which the window unit is attached, as constructed in accordance with at least one embodiment.

FIG. 4A is an isometric view of an installation strip assembly, as constructed in accordance with at least one embodiment.

FIG. 4B is a cross-sectional view of an installation strip assembly, such as along line 4B-4B of FIG. 4A, as constructed in accordance with at least one embodiment.

FIG. 4C is a cross-sectional view of a portion of an installation strip assembly, such as portion 4C of FIG. 4B, as constructed in accordance with at least one embodiment.

FIG. 4D is a directional view of an installation strip assembly, such as a view in direction D of FIG. 4B, as constructed in accordance with at least one embodiment.

FIG. 5A is an isometric view of an installation strip assembly, as constructed in accordance with at least one embodiment.

FIG. 5B is a cross-sectional view of an installation strip assembly, such as along like 5B-5B of FIG. 5A, as constructed in accordance with at least one embodiment.

FIG. 6 illustrates a method of manufacturing an installation strip assembly, as constructed in accordance with at least one embodiment.

FIG. 7 illustrates a method of installing a window or door assembly, as constructed in accordance with at least one embodiment.

### DETAILED DESCRIPTION

The following detailed description includes references to the accompanying drawings, which form a part of the detailed description. The drawings show, by way of illustration, specific embodiments in which the present assemblies, apparatuses, and methods may be practiced. These embodiments, which are also referred to herein as “examples,” are described in enough detail to enable those skilled in the art to practice the present assemblies, apparatuses, and methods. The embodiments may be combined, other embodiments may be utilized or structural or logical changes may be made without departing from the scope of the present assemblies, apparatuses, and methods. The following detailed description is, therefore, not to be taken in a limiting sense, and the scope of the present assemblies, apparatuses, and methods are defined by the appended claims and their legal equivalents.

In this document, the terms “a” or “an” are used to include one or more than one; the term “or” is used to refer to a nonexclusive “or” unless otherwise indicated; and the term “seal” refers generally to any material being used to act as a barrier to moisture between the present installation strip assembly and a window or door unit to which the strip assembly is attached, between an installation fastener and the installation strip assembly which it penetrates, or between the installation strip assembly and a building wall surrounding a rough unit opening. In addition, it is to be understood that the phraseology or terminology employed herein, and not otherwise defined, is for the purpose of description only and not of limitation.

Assemblies, apparatuses, and methods are provided herein for structurally stable installation of a window, door, or other framed unit within a rough unit opening of a wall of a building or other structure. The assemblies, apparatuses, and methods further provide one or more seal members (e.g., a unit groove seal, a fastener seal, or a wall seal) to keep water or other moisture from penetrating between the installation strip assembly and the framed unit, through one or more fastener holes in the installation strip assembly, or between the installation strip assembly and the wall surrounding the rough unit opening. In addition, the installation strip assembly may provide installation ease by way of markings, which indicate to an installer (e.g., a carpenter) as to where one or more installation fasteners may desirably be inserted, or by way of integrated flashing materials.

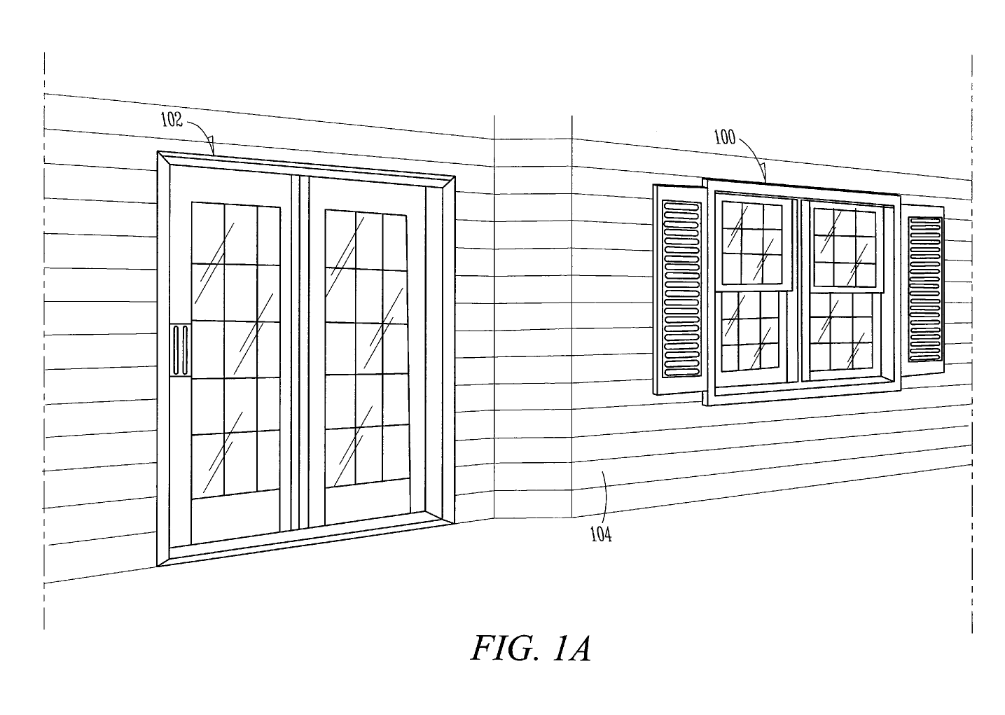

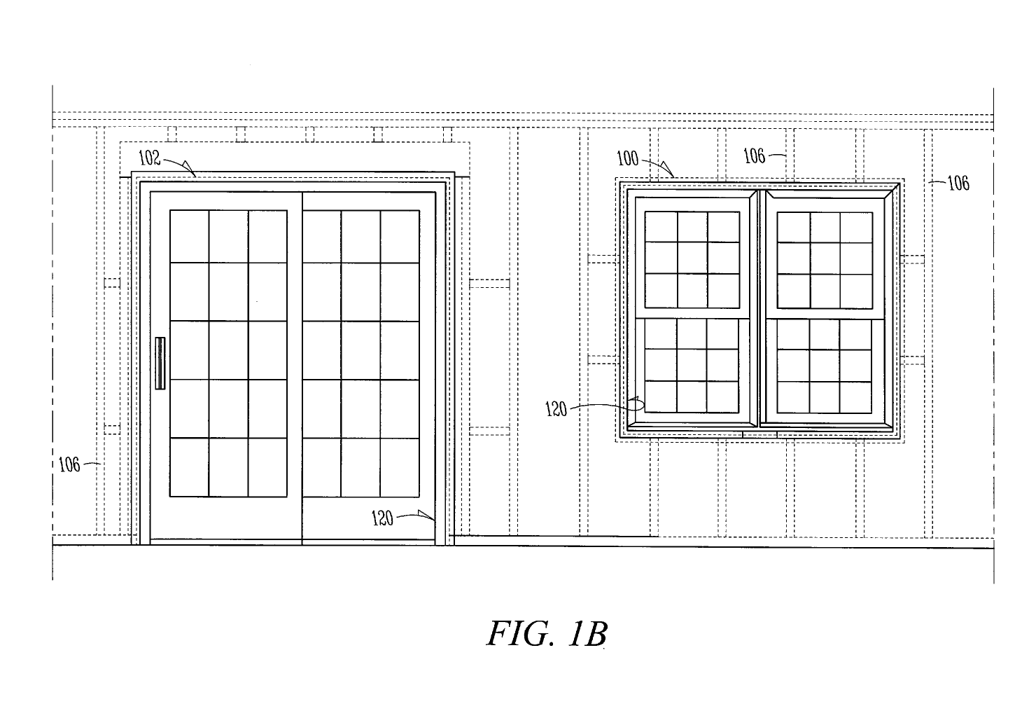

FIGS. 1A-1B illustrate one or more window units 100 and one or more door units 102 installed in a wall 104 of a building, such as a house or other structure. Specifically, FIG. 1A illustrates one or more window 100 or door 102 units and a finished environment (i.e., an exteriorly sided wall 104) in which such units may be used. Turning now to FIG. 1B, one or more window 100 or door 102 units and a structural support environment (i.e., an unfinished environment) to which such units may be attached is illustrated. As shown in FIG. 1B, the structural support environment includes, among other things, a plurality of support studs 106. Certain support studs 106 are arranged to define a rough unit opening 120 into which the one or more window 100 or door 102 units may be placed.

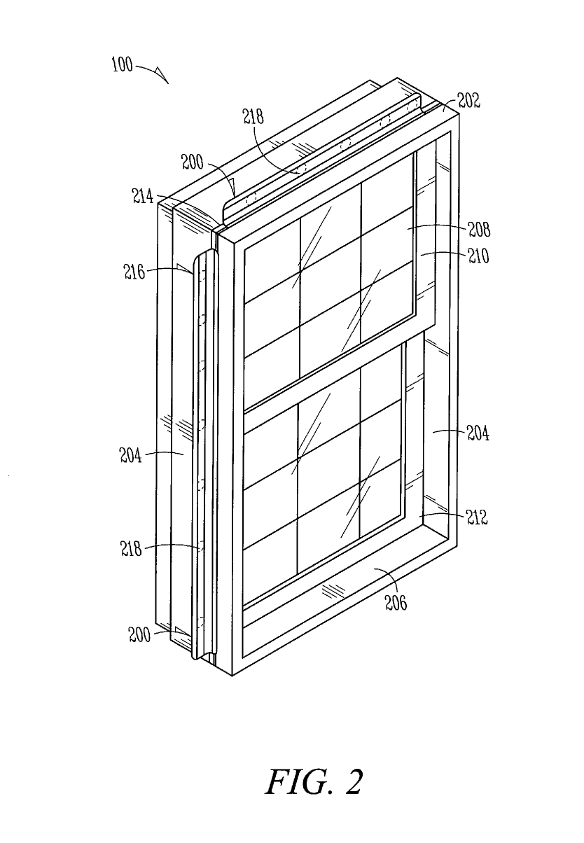

FIG. 2 depicts a window unit 100 and one or more installation strip assemblies 200 in an open (i.e., an outwardly extending) position from the window frame members (including a head jamb 202, opposing side jambs 204, and a sill 206). The window unit 100 includes a pane of glass 208 within a vinyl, plastic, aluminum, or wood frame, which may be clad in a plastic or metal outer protective layer. In the example shown, the window unit 100 further includes an upper sash 210 and a lower sash 212 supported by the opposing side jambs 204, the head jamb 202, and the sill 206. The head jamb 202 is positioned at the top and is flanked on each end by the side jambs 204. The sill 206 is located opposite the head jamb 202. In one example, the lower sash 212 is configured to slide vertically along the side jambs 204. In another example, both the upper 210 and lower 212 sashes are configured to slide vertically along the side jambs 204. In yet another example, the lower sash 210 is disposed toward an exterior of the window unit 100 (i.e., closer to an outdoor environment), while the upper sash 210 is disposed toward an interior of the window unit 100 (i.e., closer to an indoor environment).

A groove 214 is provided in at least one of the head jamb 202, the side jambs 204, or the sill 206, such that the one or more installation strip assemblies 200 may be partially inserted therein. Referring again to FIG. 1B, the installation of the window unit 100 is effected by inserting the window into a rough unit opening 120 in the wall 104 (FIG. 1A) with the one or more installation strip assemblies 200 in open position, such that a back side surface 216 of each strip assembly is rested against the surrounding support structure 106. When the window unit 100 is positioned as desired within the rough unit opening 120, one or more installation fasteners 302 (e.g., nails, screws, staples, brads, or the like) may be driven through one or more sealed fastener holes 218 in the installation strip assembly 200 and into the support structure 106 thereby firmly holding the window unit 100 in place. Alternatively, if the one or more installation fasteners are strong enough to puncture the sealed installation strip assembly 200, the one or more fasteners holes 218 may not be needed to allow advancement of the installation fasteners through the strip assembly 200 and into the support structure 106. Each installation strip assembly 200 may extend along any length portion of the corresponding window frame member 202, 204, or 206. In the example shown, each installation strip assembly 200 extends substantially the entire length of the corresponding window frame member; however, the present subject matter is not so limited.

While a double hung window unit 100 is illustrated in FIG. 2, the present subject matter is not limited thereto. Other types of window units 100, such as casement or other window units, may also be used without departing from the scope of the present subject matter. In addition, a door 102 (FIG. 1A) or other framed unit may also be used without departing from the scope of the present subject matter.

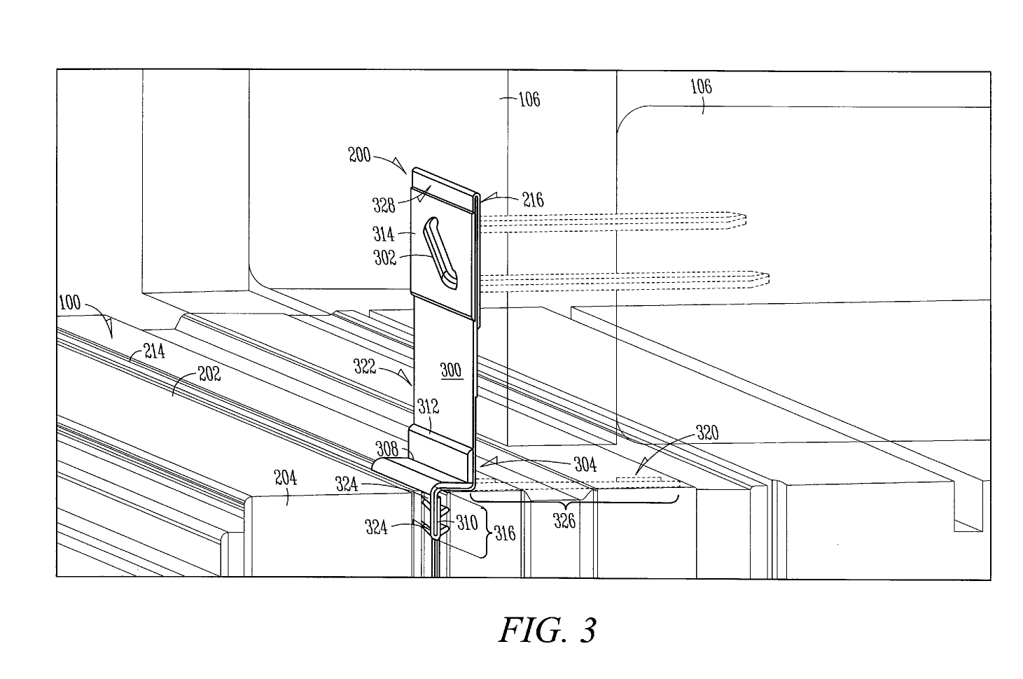

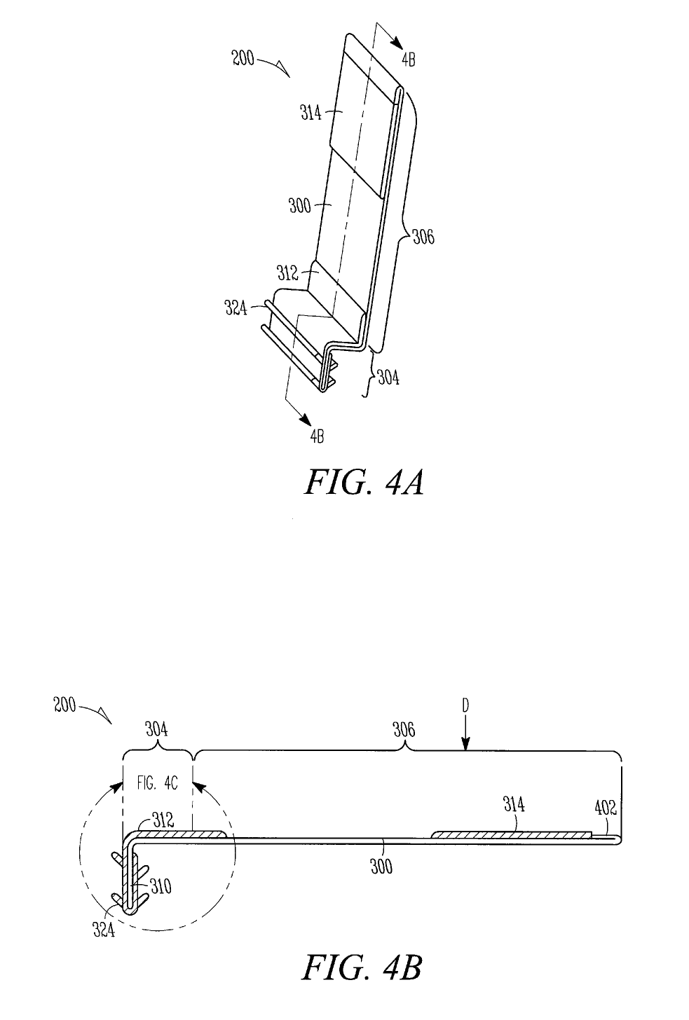

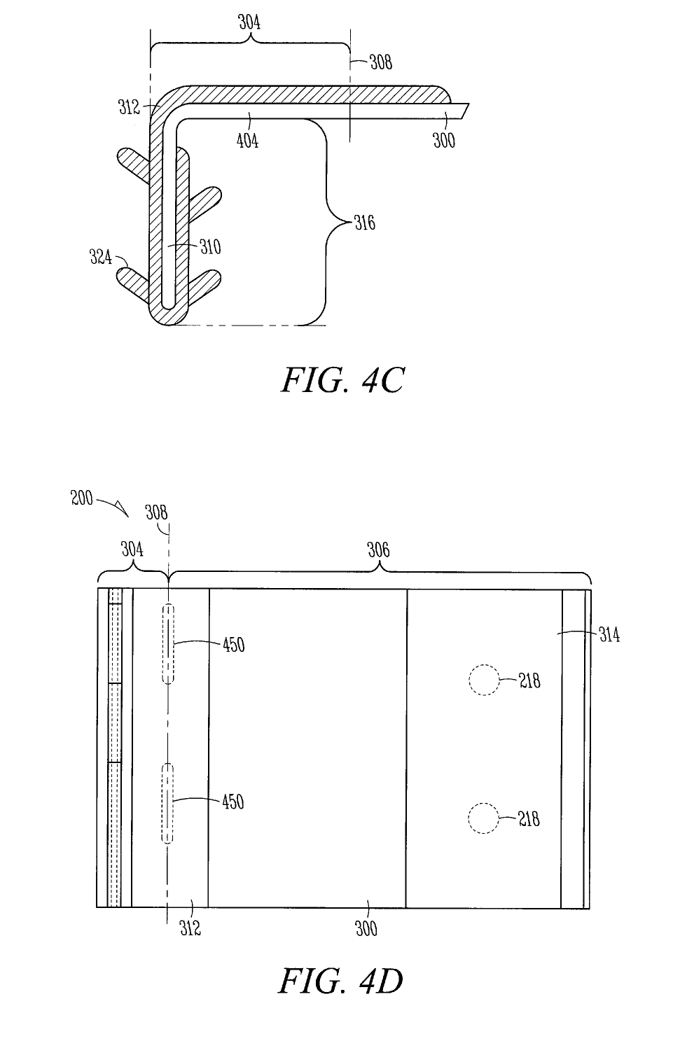

FIG. 3 illustrates a schematic view of a portion of a window unit 100, an installation strip assembly 200, and a structural support (e.g., a stud) 106 to which the window unit 100 may be attached. As shown in FIG. 3, the installation strip assembly 200 includes a main body 300, such as a rigid metal main body, having an inner portion 304 (FIG. 4A) and an outer portion 306 (FIG. 4A) interconnected along a fold line 308 (see also FIG. 4D), a unit groove seal 312, and a fastener seal 314. The fold line 308 allows the inner 304 and outer 306 portions of the main body 300 to rotatably pivot relative to one another. For instance, the fold line 308 allows the installation strip assembly 200 to pivot between a closed position 320 (i.e., a position in which the installation strip assembly 200 is flush with respect to the window frame, as shown in phantom) to an open position 322 (i.e., a position in which the installation strip assembly 200 extends outwardly from the window frame 202). In one example, the fold line 308 is established via one or more bend openings 450 (FIG. 4D) in the main body 300. In another example, the fold line 308 is established via a crimp or indentation in the main body 300.

The inner portion 304 of the main body 300 includes a groove insertion leg 310, which extends transversely from an adjacent portion of the main body, and has a substantial portion of the unit groove seal 312 disposed thereon. As shown, the unit groove seal 312 may extend from around portions of the groove insertion leg 310 to a location past the fold line 308 on the outer portion 306 of the main body 300. In one example, the portion of the unit groove seal 312 surrounding the groove insertion leg 310 includes one or more protrusions 324, each of which is configured to engage the sidewalls of a groove 214 in the window frame members 202, 204, 206. In another example, the one or more bend openings 450 (FIG. 4D) are covered by a portion of the unit groove seal 312. Advantageously, the use of the unit groove seal 312 prevents moisture from seeping in behind the installation strip assembly 200, such as between the installation strip assembly and the window frame members 202, 204, 206 to which it is attached.

The groove insertion leg 310 and portions of the unit groove seal 312, such as the portion including the one or more groove sidewall engageable protrusions 324, together form a unit groove insertion portion 316. The unit groove insertion portion 316 is configured to be received in the window frame groove 214 and retained therein by frictional engagement between the one or more protrusions 324 and the sidewalls of the groove 214.

When the unit groove insertion portion 316 is retained within the groove 214, remaining portions of the main body 300 may be moved between the closed position 320 (shown in phantom) and the open position 322 as illustrated. In the closed position 320, the majority of the installation strip assembly 200 is positioned flush against the window frame members 202, 204, 206. In one example, the window frame members 202, 204, 206 include a recessed area 326 which receives the installation strip assembly 200 when it is in the closed position, such as for storage or shipment from the factory. In another example, the recessed area 326 is larger than the installation strip assembly 200 to provide a finger-like recess for gripping the strip to pivot it to the open position 322. In the open position 322, the majority of the installation strip assembly 200 extends outwardly from window frame members 202, 204, 206, as shown in FIG. 3.

The installation strip assembly 200 includes a front facing surface 328 and a back facing surface 216. The front facing surface 328 is oriented away from the structural supports 106 to which the window unit 100 is to be attached when the installation strip assembly 200 is in the open position 322, whereas the back facing surface 216 is oriented toward the structural supports when the strip is in the open position 322.

The outer portion 306 of the main body 300 includes a fastener seal 314 and may optionally include one or more fastener holes 218 sized and shaped to receive one or more installation fasteners 302. In one example, the fastener seal 314 is bonded to the front facing surface of the outer portion 306 at a location over the one or more fastener holes 218 (FIG. 4D). In this way, the one or more installation fasteners 302 will puncture the fastener seal 314 prior to penetrating the main body 300 and the support structure 106. Among other things, the fastener seal 314 protects the main body 300 from moisture and further prevents moisture from seeping through the one or more fastener holes 218. In another example, the fastener seal 314 provides placement indicators instructing an installer (e.g., a carpenter) as to where the one or more installation fasteners 302 may desirably be inserted. As shown, the one or more installation fasteners 302 comprise a staple; however, the present subject matter is not so limited. Other fasteners such as nails, screws, brads, or the like having an engagement portion (configured to force the installation strip assembly 200 toward the support structure 106) and an attachment portion (configured to penetrate the support structure 106) may also be used without departing from the scope of this patent document and the subject matter to which it pertains.

FIG. 4A is an isometric view of an installation strip assembly 200 in an open position 322 (see FIG. 3). In the example shown, the installation strip assembly 200 includes a main body 300, such as a metal main body, having an inner portion 304 and an outer portion 306, a unit groove seal 312, and a fastener seal 314. The inner portion 304 includes a groove insertion leg 316 (FIG. 4C) extending transversely relative to an adjacent portion of the main body 300. The unit groove seal 312 is disposed, in large part, on the inner portion 304 of the main body 300, and includes at least one groove sidewall engageable protrusion 324. The fastener seal 314 is disposed on the outer portion 306 of the main body 300, such as over one or more optional fastener holes 218 (see FIG. 4D).

FIG. 4B is a cross-sectional view of an installation strip assembly 200, such as along line 4B-4B of FIG. 4A assuming the installation strip assembly 200 of FIG. 4A was pivoted from the open position 322 to a closed position 320 (see FIG. 3). As shown, the installation strip assembly 200 may comprise a substantially L-shaped main body 300 (when in the closed position 320) having a variety of widths, such as widths between 1-6 inches or more. In one example, the main body 300 comprises galvanized roll form metal. A unit groove seal 312 having one or more groove sidewall engageable protrusions 324 may surround an inner portion 304 of the main body 300, specifically a groove insertion leg 310, while a fastener seal 314 may be bonded to an outer portion 306 of the main body 300. In one example, but as may vary, the inner portion 304 of the main body 300 has a width of about 0.2 inches and the outer portion 306 of the main body 300 has a width of about 1.30 inches. In another example, the outer portion 306 of the main body 300 includes a return bend 402, which may provide added strength to the installation strip assembly 200 and a relatively blunt surface to prevent installers from injuring themselves on the otherwise sharp outer edge of the installation strip assembly 200.

FIG. 4C illustrates in greater detail a portion of the installation strip assembly 200 shown in FIG. 4B. Among other things, FIG. 4C illustrates a unit groove insertion portion 316 including a groove insertion leg 310 and portions of a unit groove seal 312. As shown, the groove insertion leg 310 extends transversely relative to an adjacent portion 404 of an inner portion 304 of a main body 300. In this example, portions of the unit groove seal 312, such as the portions including one or more groove engageable protrusions 324, surround a substantial portion of the groove insertion leg 316. In one example, each of the one or more groove engageable protrusions comprises a flexible, but resilient material, such as polypropylene, polyurethane, or polyvinylchloride. The unit groove insertion portion 316 is configured to be received in a groove 214 (FIG. 3) of a window frame member 202, 204, 206 and thereafter be retained, such as by the frictional engagement between the one or more protrusions 324 and the sidewalls of the groove 214. The attachment scheme between the installation strip assembly 200 and the frame member groove 214 beneficially provides adequate structural support to an installed window unit 100 (see, e.g., FIG. 1B), as portions of the main body 300 are inserted into the window frame groove 214 in addition to the portions of the unit groove seal 312.

FIG. 4D is a directional view of an installation strip assembly 200, such as a view in the illustrated direction D of FIG. 4B. As can be seen in FIG. 4D, a fold line 308 interconnecting a inner portion 304 and an outer portion 306 of a main body 300 may be established via one or more bend openings 450. In this example, each the one or more bend openings 450 is covered by a portion of a unit groove seal 312. Also shown in this example, a fastener seal 314 may be disposed on the main body 300 at a position over one or more optional fastener holes 218, which may be used to attached the installation strip assembly 200 to a support structure 106 surrounding the window unit 100 (FIG. 1).

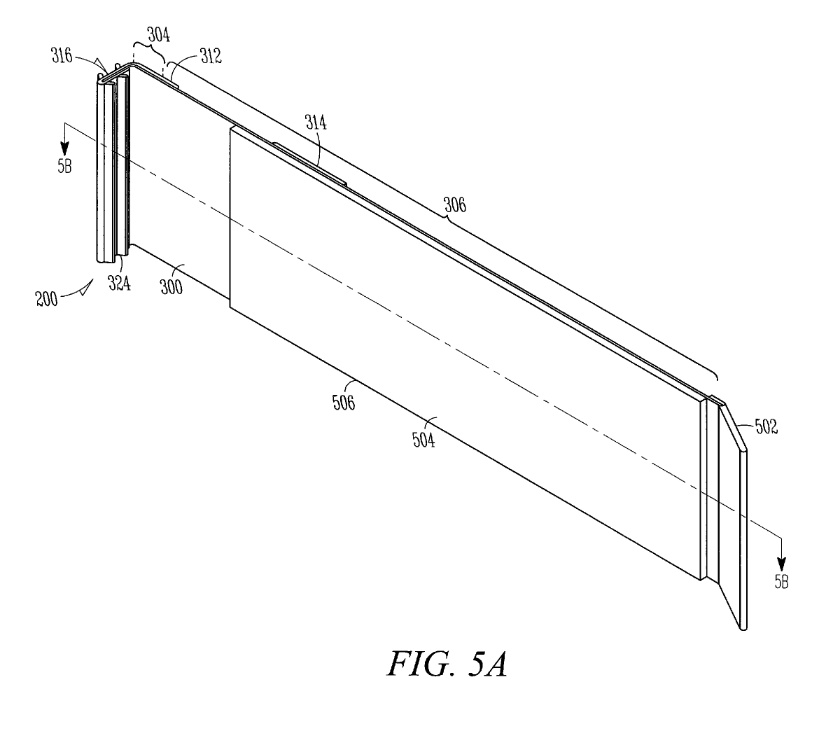

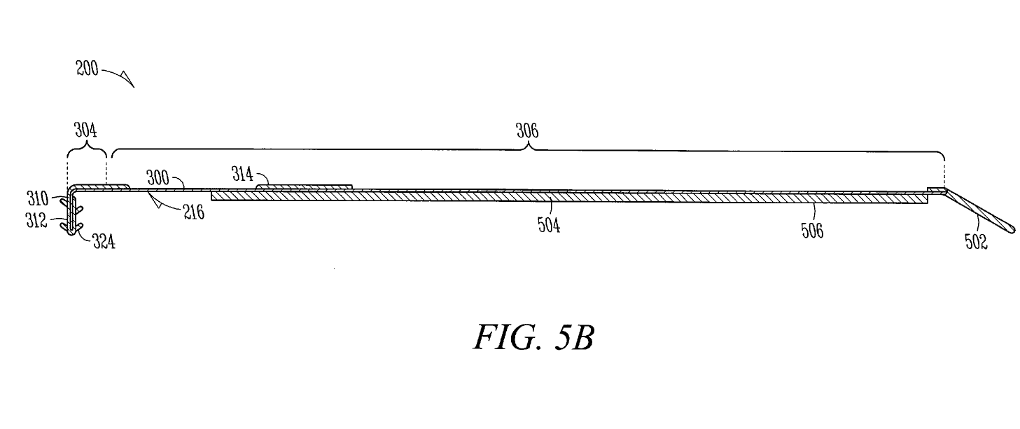

FIG. 5A is an isometric view of an installation strip assembly 200 in a closed position 320 (see FIG. 3). In this example, the installation strip assembly 200 includes a main body 300, such as a metal main body, having an inner portion 304 and an outer portion 306, a unit groove seal 312, a fastener seal 314, a wall seal 502, a flashing seal 504, and a release paper 506. The inner portion 304 includes a groove insertion leg 316 extending transversely relative to an adjacent portion of the main body 300. The unit groove seal 312 is disposed, in large part, on the inner portion 304 of the main body 300, and includes at least one groove sidewall engageable protrusion 324. The fastener seal 314 is disposed on the outer portion 306 of the main body 300 in an installation fastener insertion area. As shown, the outer portion 306 of the main body may further include the flashing seal 504, the release paper 506, and the wall seal 502.

FIG. 5B is a cross-sectional view of an installation strip assembly 200, such as along line 5B-5B of FIG. 5A. As shown, the installation strip assembly 200 may comprise a substantially L-shaped main body 300 (when in the closed position 320 (see FIG. 3)) having a variety of widths, such as widths between 1-6 inches or more. At certain widths (e.g., the wider widths), the installation strip assembly 200 may include a flashing seal 504, such as a butyl or asphalt type of adhesive, and a release paper 506 disposed on a back side surface 216 of the strip assembly. When a window 100 or door 102 unit is installed in a rough unit opening 120 (FIG. 2), the release paper 506 may be removed allowed the flashing seal 504 to bond with an adjacent support structure 106 or wall 104 surrounding the rough unit opening 120. The flashing seal 504 may further deter water or other moisture from leaking into, and damaging, the building's support structure 106 or wall 104. The flashing seal 504 may extend along any length portion of the corresponding installation strip assembly 200. Advantageously, by consolidating the flashing seal 504 with the installation strip assembly 200, one or more steps of window 100 or door 102 unit installations may be eliminated.

A unit groove seal 312 having one or more groove sidewall engageable protrusions 324 may surround an inner portion 304 of the main body 300, specifically a groove insertion leg 310, while a fastener seal 314 may be bonded to an outer portion 306 of the main body 300. In certain examples, the installation strip assembly 200 may further include a wall seal 502, such as a flexible wall seal, to direct moisture away from the rough unit opening 120 (FIG. 2). When one or more installation fasteners 302 (FIG. 3) are inserted through the fastener seal 314 and the main body 300, the wall seal 502 compresses against a surrounding building wall 104 (FIG. 1) thereby forming a seal therebetween. In one example, but as may vary, the inner portion 304 of the main body 300 has a width of about 1.3 inches and the outer portion 306 of the main body 300 has a width of about 3.5-5.5 inches.

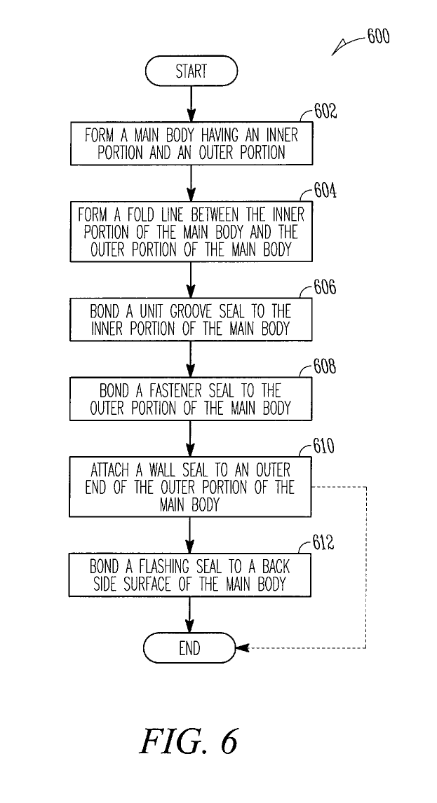

FIG. 6 illustrates a method 600 of manufacturing one or more installation strip assemblies insertable into a groove of a window or door frame member. At 602, a main body having an inner portion and an outer portion is formed. Forming the inner portion of the main body includes forming a groove insertion leg, which extends transversely from an adjacent portion of the main body. In one example, the main body comprises a rigid metal, such as galvanized roll metal. At 604, a fold line extending between the inner and outer portions of the main body is formed. In one example, the fold line is formed by the creation of one or more bend openings in the main body. In another example, the fold line is formed via a crimp or indentation in the main body.

At 606, a unit groove seal is optionally bonded, in large part, to the inner portion of the main body, thereby creating a lineal seal between the installation strip assembly and the window or door unit frame member to which it is attached. Among other things, bonding the unit groove seal may include bonding one or more groove sidewall engagement protrusions to the groove insertion leg of the inner portion of the main body. In one example, the unit groove seal is bonded over the one or more bend openings to prevent the passage of moisture therethrough.

At 608, a fastener seal is optionally bonded to the outer portion of the main body. Among other things, bonding the fastener seal to the outer portion of the main body may include bonding a portion of the fastener seal over one or more optional fastener holes, thereby creating a seal between an inserted installation fastener and the main body.

At 610, a wall seal is optionally attached to an outer end of the outer main body portion to direct moisture away from a rough unit opening. In certain examples, a flashing seal covered by a removable release paper may be bonded to a back side surface of the installation strip assembly at 612, such as for providing a further seal between the inserted installation fastener and the main body.

After the one or more installation strip assemblies are manufactured, each strip assembly may be coupled with a window or door unit frame by inserting the groove insertion leg and unit groove seal bonded to portions thereof into a groove of the frame. As phantomly shown in FIG. 3, when the one or more installation strip assemblies are initially attached to the window unit, for example, each strip assembly may be positioned in a flush relationship with respect to the window unit frame (i.e., each strip assembly is initially attached in a closed position). In this way, the window unit may be shipped from the factory to the building site in a convenient manner because the one or more installation strip assemblies do not protrude outwardly from the window unit frame. Such folded configuration of the installation strip assembly during transport prevents the strips from becoming damaged during shipment.

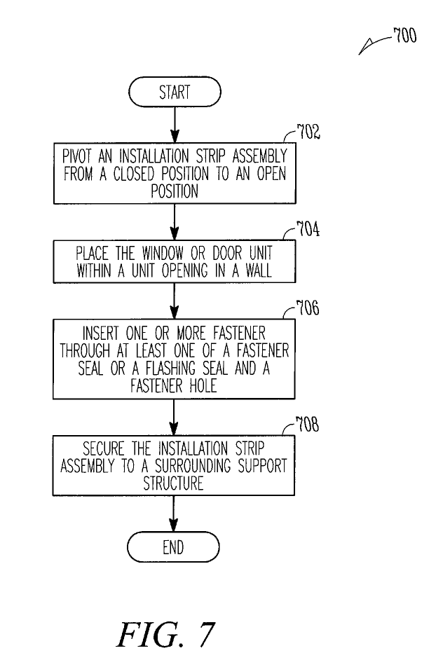

FIG. 7 illustrates a method of mounting a window or door unit to a support structure surrounding a rough unit opening in a wall. When the window or door unit arrives at the job or building site and after the unit is in position or is ready to be put into the rough unit opening, an installation strip assembly is pivoted from the closed position to an open position at 702. In one example, the installation strip assembly is pivoted along a fold line established via one or more bend openings, which may be covered by a portion of a unit groove seal. Pivoting the installation strip assembly includes moving an outer portion of the strip from a position substantially flush with a frame member of the window or door unit to a position in which the outer portion extends outwardly from the frame member.

At 704, the window or door unit is moved into the rough unit opening where, at 706, one or more installation fasteners are inserted through at least one of a fastener seal or a flashing seal and a main body of the installation strip assembly, such as through an optional fastener hole. In varying examples, the one or more installation fasteners are inserted through the fastener seal prior to being inserted through the fastener hole. In this way, moisture is prevented from seeping through the fastener hole and into the supporting structure. At 708, the installation strip assembly is secured to the surrounding support structure, which in one example, includes stapling or otherwise attaching the strip to outside sheathing and interior studs of a wall using one or more staples.

As discussed herein, a foldable installation strip assembly for a framed unit, such as a window or door unit, comprises a main body having an inner portion and an outer portion. In certain examples, a portion of the inner portion, in conjunction with a unit groove seal disposed on the inner portion, is positioned in and retained by a groove of a unit frame member. The unit groove seal provides a seal between the installation strip assembly and the framed unit. The installation strip assembly is typically positioned in a substantially flush configuration with respect to the frame prior to use. At the job or building site, the installation strip assembly may be folded from its substantially flush position to an outwardly extending position so that the strip may be secured using one or more fasteners to a building or other support structure extending around a rough unit opening formed therein. The upper portion of the main body includes at least one of a fastener seal or a flashing seal, which provide a seal between the one or more fasteners and the main body, and optionally a wall seal to further prevent moisture from damaging the building's support structure.

Advantageously, the present installation strip assemblies provide structural support to an installed window, door, or other framed unit, while at the same time keep water or other moisture from penetrating between the strip assembly and the framed unit, through one or more installation fastener holes, or between the strip assembly and a building wall surrounding the rough unit opening. In addition, the present installation strip assemblies may guide an installer (e.g., a carpenter) as to where to desirably place the one or more installation fasteners. Further, the present installation strip assemblies may reduce the number of steps required in window or door unit installation via strip integrated flashing materials.

While the present installation strip assemblies may be used with a variety of units enclosed by, or having, a peripheral frame, a majority of the foregoing description is cast in terms of the installation strip assembly's use with a window unit for brevity purposes. Such description is not intended, however, to limit the scope of the present subject matter in any way.

It is to be understood that the above description is intended to be illustrative, and not restrictive. As one example, the placement of the unit groove seal, the fastener seal, the flashing seal, or the wall seal on the main body may vary depending on the installation strip design. As another example, the above-described embodiments (or characteristics thereof) may be used in combinations with each other beyond those discussed. Many other embodiments will be apparent to those of skill in the art upon reviewing the above description. The scope of the present assemblies, apparatuses, and methods should, therefore, be determined with reference to the appended claims, along with the full scope of legal equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, assembly, article, or process that includes elements in addition to those listed after such a term in a claim are still deemed to fall within the scope of that claim.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. An installation strip assembly comprising:
a main body having an inner portion and an outer portion interconnected along a fold line, the inner portion including a groove insertion leg which extends transversely from an adjacent portion of the main body;
a unit groove seal disposed, in part, on the inner portion of the main body, the unit groove seal having at least one groove sidewall engageable protrusion;
at least one of a fastener seal or a flashing seal disposed on the outer portion of the main body; and
the groove insertion leg of the main body and the portion of the unit groove seal including the at least one groove engageable protrusion together forming a unit groove insertion portion.

2. The installation strip assembly of claim 1, further comprising a wall seal disposed at an outer end of the main body outer portion.

3. The installation strip assembly of claim 1, wherein the fold line is covered by a portion of the unit groove seal.

4. The installation strip assembly of claim 1, wherein the unit groove seal extends from the groove insertion leg to a location on the outer portion of the main body near the fold line.

5. The installation strip assembly of claim 1, further comprising one or more fastener holes sized and position to receive an installation fastener.

6. The installation strip assembly of claim 1, wherein the main body comprises a metal.

7. An installation strip assembly comprising:
a main body having an inner portion and an outer portion interconnected along a fold line, the inner portion including a groove insertion leg which extends transversely from an adjacent portion of the main body;
a unit groove seal disposed, in part, on the inner portion of the main body, the unit groove seal having at least one groove sidewall engageable protrusion; and
the groove insertion leg of the main body and the portion of the unit groove seal including the at least one groove engageable protrusion together forming a unit groove insertion portion.

8. The installation strip assembly of claim 7, further comprising a wall seal disposed at an outer end of the main body outer portion.

9. The installation strip assembly of claim 7, wherein the unit groove seal extends from the groove insertion leg to a location on the outer portion of the main body near the fold line.

10. The installation strip assembly of claim 7, wherein the main body comprises a metal.

11. An installation strip assembly insertable into a groove of a unit frame member, the installation strip assembly comprising:
a main body having an inner portion and an outer portion interconnected along a fold line, the inner portion including a groove insertion leg which extends transversely from an adjacent portion of the main body;
at least one of a fastener seal or a flashing seal disposed on an installation fastener receiving portion of the main body; and
the groove of the unit frame member receives and retains the groove insertion leg therein.

12. The installation strip assembly of claim 11, further comprising a wall seal disposed at an outer end of the main body outer portion.

13. The installation strip assembly of claim 11, wherein the main body comprises a metal.

14. The installation strip assembly of claim 11, wherein the fastener seal is disposed on a front side surface of the main body and the flashing seal is disposed on a back side surface of the main body.

15. An apparatus comprising:
a window or door unit in a plane having a frame including at least a top and two oppositely positioned side members, at least one of the frame members having an outside face oriented perpendicular to the plane and having a groove extending along a length thereof;
one or more installation strip assemblies, including:
a main body having an inner portion and an outer portion interconnected along a fold line, the inner portion including a groove insertion leg extending transversely from an adjacent portion of the main body;
a unit groove seal disposed, in part, on the inner portion of the main body, the unit groove seal extending from around the groove insertion leg to a location past the fold line on the outer portion of the main body;
at least one of a fastener seal or a flashing seal disposed on the outer portion of the main body; and
the groove of the window or door unit receives and retains the groove insertion leg and portions of the unit groove seal disposed on the groove insertion leg therein.

16. The apparatus of claim 15, further comprising a wall seal disposed at an outer end of the main body outer portion.

17. The apparatus of claim 15, wherein at least one installation strip assembly longitudinally extends a substantial portion of a length of a corresponding frame member.

18. The apparatus of claim 15, wherein each installation strip assembly is pivotable between a closed position in which the installation strip lies substantially flush against a corresponding frame member outside face and an open position in which the installation strip extends outwardly from the corresponding frame outside face.

19. The apparatus of claim 15, wherein the unit groove seal is positioned, in part, over the fold line to prevent moisture passing therethrough.

20. The apparatus of claim 15, wherein the unit groove seal includes one or more groove sidewall engageable protrusions securing each installation strip assembly within the groove of a corresponding frame member.

21. The apparatus of claim 15, wherein the main body comprises a metal.

22. The apparatus of claim 15, further comprising an installation fastener extending from a proximal end to a distal end, the proximal end including an installation strip engagement portion and the distal end including a support structure attachment portion.
